(19) United States
(12) Patent Application Publication
(10) Pub. No.: US 2018/0375826 A1
(43) Pub. Date: Dec. 27, 2018

(54) ACTIVE NETWORK BACKUP DEVICE

(71) Applicants: SHENG-HSIUNG CHANG, NEW TAIPEI CITY (TW); SHENG-YUAN CHANG, NEW TAIPEI CITY (TW)

(72) Inventors: SHENG-HSIUNG CHANG, NEW TAIPEI CITY (TW); SHENG-YUAN CHANG, NEW TAIPEI CITY (TW)

(21) Appl. No.: 15/631,159

(22) Filed: Jun. 23, 2017

(51) Int. Cl. H04L 29/06; G06F 3/06

(52) U.S. Cl. CPC H04L 63/0209; G06F 3/067; G06F 3/065; G06F 3/0619

(57) ABSTRACT

An active network backup device includes at least a mainframe and a hardware. The mainframe and other network devices cannot log in, create settings and access data of the hardware. Hence, the hardware can practically prevent and block viruses, ransomware and attacks by hackers; moreover, the device has a physical security switch design for switching on and off a port to ensure personal operation of the administrator and prevent the hardware from being hacked by robot program. Most importantly, the hardware cannot execute destructive instructions and thereby viruses cannot be executed or run in the hardware, which also prevents accidental deletion due to setting errors, or any ransomware or malicious programs in the disguise of setting programs being downloaded and executed by careless users.

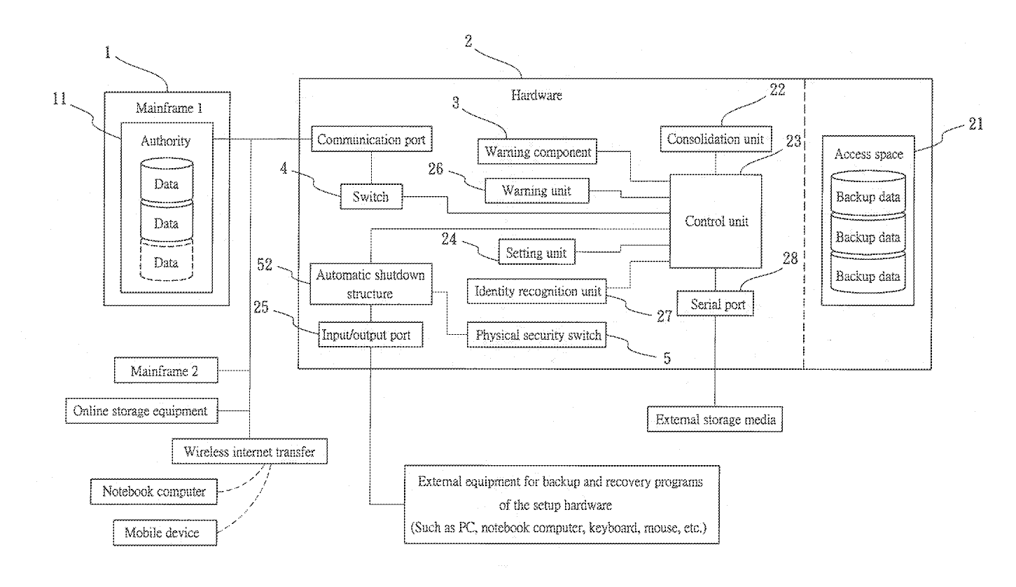

### BACKGROUND OF THE INVENTION

### 1. Field of the Invention

The present invention relates generally to an active network backup device, and more particularly to a technology for network security. The key technology of the present invention mainly lies in the design of an independent hardware storage space without Internet connection so that the security administrator can precisely protect backup data and more importantly, by application of software and hardware and after taking human factors into consideration, file security has been enhanced through multi-protection. Further, execution will automatically take place without human intervention as soon as settings are completed, which effectively prevents negative impacts of human factors (e.g. loafing, negligence) on file security. It is an invention of considerable practicability.

### 2. Description of Related Art

The presently flourishing technology enables information transmission through wireless network in most cases for the sake of saving time and shortening the distance between people. Encryption or cloud storage is generally adopted as data security methods, in which way, only users can access and download the data. However, there are plenty of Internet law breakers (known as hackers) who commit crimes by attacking websites or blackmailing users. Some even cause network paralysis or spread viruses. It is a real headache for the individuals and companies having high demands for privacy. To solve the problems, relevant practitioners have further developed and launched the so-called security devices and firewalls to tackle the illegal acts of hackers, which have successfully blocked or even isolated viruses and attacks for a time as expected and yet, under constant attacks carried out by the “skilled” hackers, the security devices and firewalls usually break down and thus similar events happen again and again.

Presently, there are a number of companies provide data storage service for users, mainly other companies, to prevent data from missing or corruption due to hackers' attacks against internal systems, or failure in file recovery due to operators' negligence. These companies aim to provide solutions to said problems and yet, in terms of data backup, these security companies depend on the Internet to realize data transmission, which, without doubt, is vulnerable to hackers' attacks. Hence, the backup approaches of the security companies, to a great extend, have serious deficiencies.

Thus, to overcome said problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The present invention mainly aims at backup data protection by providing absolute security and convenient classification, compression and encryption. Besides, the backup and restore process is practically active data access of CPU without taking up any resources or space of a mainframe or network storage devices, which has improved the commonly used backup technology that requires the mainframe or network storage devices connecting to the Internet in the backup process and easily causes data corruption or blackmail under hacker's attacks or in infection of viruses. Therefore, to meet this end and fulfill said efficacy, three embodiments of the present invention are provided, including an active network backup device comprised of at least a mainframe (e.g. SERVER, PC, NB, NAS or other network storage devices, hereinafter referred to as the “mainframe”) having an authority unit; a piece of hardware directly or indirectly connected to at least a mainframe in a wired or wireless local area network and having an internal access space for storing the data copied from at least the mainframe, and the authority unit of at least the mainframe accessible by the hardware to actively and unilaterally grab and copy data from the mainframe and unilaterally write data in the process of backup data restore in the mainframe, and a consolidation unit designed for collation, compilation, compression and encryption of data in the access space, and a control unit to control the reading and writing of data in the mainframe and operation of the hardware; particularly, the mainframe and other network devices are not authorized to log in the hardware, provide settings or perform data access. Hence, the hardware is under real protection against attacks by viruses, ransomware and hackers.

The present invention, according to said description and definition, has the technical feature further characterized in that, the hardware, as aforementioned, can only conduct backup and restore operations when directly or indirectly connected to at least a mainframe in a wired or wireless local area network because it has no access to the Internet in order to fundamentally prevent intrusion of malicious programs.

The present invention, according to said description and definition, has the technical feature further characterized in that, the hardware, further has a setting unit and an independent wired or wireless port, the setting unit being a program setting unit designed for data backup and restore of the mainframe, and the independent wired or wireless input/output port being the essential device used for connecting the hardware to external devices (e.g. mobile devices, keyboard, mouse or monitor) for operation and setting of the setting unit, the connections between the external devices and the hardware being independent and isolated from the connection between the hardware and the mainframe, to forbid setting and operation of the hardware with the mainframe and thereby prevent intrusion of viruses, ransomware and hackers into the hardware through the mainframe.

The present invention, according to said description and definition, has the technical feature further characterized in that, the hardware, further has a detection and warning unit, the detection and warning unit being mainly used for detection of the copied data in the access space and original data in the mainframe to be copied and further control over the warning notifications given by a warning component of the hardware; the warning component is a speaker, buzzer, flasher or acousto-optic device, or a program of warning functions installed in and connected to the mainframe and warning users via acousto-optic approaches, message or email from the mainframe upon notification given by the program.

The present invention, according to said description and definition, has the technical feature further characterized in that, the hardware, further has a switch designed for forcibly breaking the working connection between the hardware and the mainframe and used for automatically or manually breaking the connection between the hardware and the mainframe when the system gives warnings of virus or hacker intrusion.

The present invention, according to said description and definition, has the technical feature further characterized in that, the hardware can be installed in at least a mainframe or have independent settings.

The second embodiment of the present invention is an active network backup device having a physical security switch comprised of at least a mainframe having an authority unit; a piece of hardware directly or indirectly connected to at least a mainframe in a wired or wireless local area network and having an internal access space for storing the data copied from at least a mainframe, and the authority unit of at least the mainframe accessible by the hardware to actively and unilaterally grab and copy data from the mainframe and unilaterally write data in the process of backup data restore in the mainframe; besides, the hardware has a physical security switch controlling at least one wired or wireless independent input/output port of the hardware with the independent input/output port being used for connecting external input devices to complete backup and restore program settings of the hardware. The physical security switch is at least comprised of a manual switch, a lock or a fingerprint or iris recognition device; particularly, before the administrator creates or changes the settings of the mainframe with the hardware, the physical security switch must be opened manually in order to access the independent input/output port and complete settings of the hardware, in which way, the administrator's personal operation ensures prevention against hacking of robot programs.

The present invention, according to the description and definition of the second embodiment, has the technical feature further characterized in that, the hardware has an identity recognition unit requiring the administrator to pass an identity verification program by entering password or voice recognition before login and operation of the hardware when the physical security switch is manually turned on and no fingerprint or iris recognition is applied, in order to ensure that it is the administrator who personally operates the hardware.

The present invention, according to the description and definition of the second embodiment, has the technical feature further characterized in that, the physical security switch has the automatic shutdown structure resetting the timer and postponing the automatic disconnection function when receiving the correct setting message within the effective timing period to avoid negligence of administrator in personal operation from forgetting to shut down the independent input/output port of the hardware or disconnect the hardware from the keyboard, mouse, monitor, mobile phone, portable devices and other external input/output devices used in the process of hardware setting.

The present invention, according to the description and definition of the second embodiment, has the technical feature further characterized in that, the automatic shutdown structure will first give a warning of the coming disconnection when meeting the shutdown conditions so that users can postpone the automatic shutdown by repeating the operation on the physical security switch or entering the correct setting message.

The third embodiment of the present invention is an active network backup device having the function of ruling out file corruption instructions, which is comprised of: at least a mainframe having an authority unit; a piece of hardware, directly or indirectly connected to at least a mainframe in a wired or wireless local area network and having an internal access space for storing the data copied from at least the mainframe, and the authority unit of at least the mainframe accessible by the hardware to actively and unilaterally grab and copy data from the mainframe and unilaterally write data in the process of backup data restore in the mainframe; particularly, to ensure the security of backup files, the hardware cannot execute destructive instructions, such as deleting, revising or opening files (execution of files) or other instructions to destroy or change files but the nondestructive instructions such as creating, moving, copying, backup and restore of data. If any backup data copied to the hardware are previously infected by viruses, because the viruses cannot be executed or run in the hardware, the previous backup data will not be destroyed. In addition, the data are protected from accidental deletion due to setting errors, or any ransomware or malicious programs in the disguise of setting programs being downloaded and executed by careless users.

The present invention, according to the description and definition of the third embodiment, has the technical feature further characterized in that, the hardware has a serial port for connection with external backup media with the serial port being used for connecting to storage media in order to save space by moving the old and outdated backup data from the access space. During execution of the moving instruction, if no external medium is connected to the hardware, the moving instruction will stop.

Therefore, the present invention is considerably practical and progressive and it worth extensive promotion in the industry to introduce it to the social public.

### BRIEF DESCRIPTION OF THE DRAWINGS

The Figure is a block diagram of the present invention.

### DETAILED DESCRIPTION OF THE PREFERRED EMBODIMENT

To clearly and explicitly prove that the present invention can fulfill said purposes and efficacy, illustrations are hereby provided to elaborately describe the characteristics and efficacy of the embodiments of the present invention. Referring to the Figure, the present invention has three embodiments. The first embodiment is an active network backup device, which is comprised of: at least a mainframe 1 having an authority unit 11; a piece of hardware 2 directly or indirectly connected to at least a mainframe 1 in a wired or wireless local area network and having an internal or external access space 21 for storing the data copied from at least the mainframe 1, and the authority unit 11 of at least the mainframe 1 accessible by the hardware 2 to actively and unilaterally grab and copy data from the mainframe 1 and unilaterally write data in the process of backup data restore in the mainframe 1; the hardware 2 has a built-in consolidation unit 22 designed for collation and compilation of data in the access space and a built-in control unit 23 used for control over data reading and writing in the mainframe 1 and operation of the hardware 2; particularly, the mainframe 1 and other network devices are not authorized to log in the hardware 2, provide settings or perform data access. Therefore, there is at least a set of secure and independent backup data in the hardware 2 under real protection against attacks by viruses, ransomware and hackers (said is the primary technical characteristics of the main embodiments of the present invention corresponding to claim 1 herein, which provides detailed information of the purposes and embodiments of the present invention. The technical characteristics described in other claims should be considered as elaboration or additional technical characteristics to claim 1 instead of a defined scope to restrain claim 1. It should be noted that Claim 1 is not necessary to include the technical characteristics described in other claims herein).

Generally, malicious software, ransomware, viruses and hackers are the greatest threat to companies and organizations holding extremely confidential files, especially in Internet connection when the data, files and software of a mainframe are vulnerable to the widespread viruses, ransomware, malicious software and attacks by hackers, under which condition, the valuable files and data are easily lost or damaged. Although there are numerous firewall products and anti-virus and anti-theft software available in the market, these products, in fact, have limited effects. Moreover, considering the constant technology development and malicious attempts of law breakers, even the so-called perfect firewalls and security software that still have flaws and vulnerabilities are possible to break down. Therefore, continuous backup is the only solution to minimize loss. The present invention, based on the non-Internet connection between the hardware 2 and the mainframe 1, uses the hardware 2 as an independent device and the hardware 2 is only connected to the mainframe 1 through the authority unit 11 enabling transmission between the mainframe 1 and the hardware 2 and the hardware 2 unilaterally grabbing data from the mainframe 1 and store the data in the access space 21 as backup data. The data copied into the access space 21 will be classified and sorted out by the consolidation unit 22 of the hardware 2. Because no Internet connection is required in the process, the data are protected from most attacks and intrusion by viruses, ransomware and hackers through the Internet; besides, if a company loses the data in a mainframe 1, the original sources can be traced with the backup data in the hardware 2 and yet, during the process of data recovery by copying the data in the hardware 2 back to the mainframe 1, the hardware 2 has to obtain authority of the mainframe 1 before completely copying the data that are not infected (damaged) and originally stored in the access space 21 back to the mainframe 1, in which way, users can continue the original operation without spending extra time and efforts by starting over due to loss of files.

Based on said first embodiment of the present invention, the hardware 2 and the mainframe 1 must be directly or indirectly connected in a wired or wireless local area network to realize data backup and restore between the hardware 2 and the mainframe 1 because the hardware 2 has no access to the Internet and the mainframe 1 and other devices cannot control or access data in the hardware 2, with which design, the hardware 2 is protected from intrusion of malicious programs, viruses and ransomware and the backup data will not be damaged; moreover, as shown in the Figure, the design of the hardware 2 of the present invention is further improved by installing a setting unit 24 and an independent wired or wireless port 25, with the setting unit 24 designed for data backup and restore program settings of data in the mainframe 1 with the hardware 2, e.g. using the setting unit 24 for backup setting of important data in the mainframe 1 with the hardware 2, such as data selection, backup cycle, backup location and restore date (to restore the existing data till a specific date). Said is provided for illustrative purpose, instead of limiting conditions of settings. Further, the setting unit 24 must be in wired or wireless connection through the independent port 25 of the hardware 2 to ensure users' operation and settings of the hardware 2 with the setting unit 24 while the port 25 can be connected to external devices for users' operation. Said external devices such as mobile devices, keyboard, mouse or monitor connected to the hardware 2 with the port 25 will not interfere and is different from the connection between the hardware 2 and the mainframe 1. Hence, these connections are isolated from each other and thereby viruses, ransomware and hackers cannot intrude into the hardware 2 through the mainframe 1, as shown in the Figure.

Referring to the Figure, to ensure that users can immediately determine whether the backup and restored data copied from the mainframe 1 to the hardware 2 are normal or not, the hardware 2 is further equipped with a detection and warning unit 26, the detection and warning unit 26 being mainly used for detection of the copied data in the access space 21 and original data in the mainframe 1 to be copied and further control over the warning notifications given by a warning component 3 of the hardware 2; the warning component 3 is a speaker, buzzer, flasher or acousto-optic device. In the backup process of data in the mainframe 1 with the hardware 2, if abnormal changes in data to be copied as backup data is identified, since the detection and warning unit 26 is always in the state of detection, the warning component 3 will be activated upon detection of abnormalities and a message of abnormalities or warning notification will be sent to the mainframe 1 or users' portable devices so that users of the hardware 2 can be immediately informed of the problems and abnormalities of the mainframe 1; besides, the hardware 2 of the present invention can operate independently and be isolated from the mainframe 1, or the hardware 2 is installed in at least a mainframe 1 or NAS or other network storage devices 1.

Lastly, the design of the hardware 2 of the present invention is further improved by installation of a switch 4 mainly used for immediately stopping operation if users notice any problems. Therefore, with the design of the switch 4, the working connection between the hardware 2 and the mainframe 1 can be forcibly broken, which can be used for automatically or manually breaking the connection between the hardware 2 and the mainframe 1 when the system gives warnings of virus or hacker intrusion. It ensures security of the hardware 2 and the mainframe 1 and the completeness of data, as shown in the Figure.

Based on said first embodiment of the present invention, the second embodiment differs from the first embodiment in that the hardware 2 has a physical security switch 5. The physical switch 4 controls the wired or wireless independent input/output port 25 of the hardware 2 while the independent input/output port 25 is used for backup and restoring program setting of the hardware 2. The physical security switch 5 is comprised of at least a manual switch or a lock or a fingerprint or iris recognition device as shown in the Figure. Before the administrator creates or changes the settings of the mainframe 1 with the hardware 2, the physical security switch 5 must be opened manually in order to access the independent input/output port 25 and complete settings of the hardware2, in which way, the administrator's personal operation ensures prevention against hacking of robot programs, as shown in the Figure.

Following said description, to ensure that it is a user who initiate the operation of the hardware 2, the hardware 2 has an identity recognition unit 27 requiring the administrator to pass an identity verification program by entering password or voice recognition before login and operation of the hardware 2 when the physical security switch 5 is manually turned on and no fingerprint or iris recognition is applied, in order to ensure that it is the administrator (user) who personally operates the hardware, as shown in the Figure; further, to achieve perfect prevention against intrusion of viruses and ransomware, strict restriction on the time of use should be applied and thus, the physical security switch 5 has an automatic shutdown structure 52 resetting the timer and postponing the automatic disconnection function when receiving the correct setting message within the effective timing period to avoid negligence of administrator in personal operation from forgetting to shut down the independent input/output port 25 of the hardware 2 and thereby prevent viruses and software from intruding into the hardware 2 through the connection and automatic shutdown structure 52 will first give a warning of the coming disconnection when meeting the shutdown conditions so that users can postpone the automatic shutdown by repeating the operation on the physical security switch 5 or entering the correct setting message, as shown in the Figure.

Lastly, the third embodiment of the present invention is mainly different from said two embodiments in that, to ensure the security of backup files, the hardware 2 cannot execute destructive instructions, such as deleting, revising or opening files (execution of files) or other instructions to destroy or change files but the nondestructive instructions such as creating, moving, copying, backup and restore of data. If any backup data copied to the hardware 2 are previously infected by viruses, because the viruses cannot be executed or run in the hardware 2, the previous backup data will not be destroyed. In addition, the data are protected from accidental deletion due to setting errors and ransomware or malicious programs in the disguise of setting programs cannot destroy any files even they are downloaded and executed by the careless users; besides, the hardware 2 has a serial port 28 for connection with external backup media with the serial port 28 being used for connecting to storage media in order to save space by moving the old and outdated backup data from the access space 21. During execution of the moving instruction, if no external medium is connected to the hardware 2, the moving instruction will stop, as shown in the Figure.

The above descriptions are only used to explain the preferred embodiments of the present invention, but do not attempt to, according to the present invention, impose any form of restrictions, and therefore, where there is made in the spirit of the invention under the same in relation to any modifications or changes to the present invention, all should still include in the scope of the present invention is intended protection.

To summarize, the present invention, namely the “active network backup device”, has truly and completely met the demands of industrial development in terms of practicality and cost efficiency and disclosed an unprecedented innovative structure of invention. Therefore, it is, without doubt, an “innovation”. Moreover, the present invention has outperformed the commonly used structures in terms of efficacy and thus the present invention has shown its “progressiveness”.

What is claimed is:

1. An active network backup device, comprised of:
at least a mainframe having an authority unit;
a piece of hardware directly or indirectly connected to at least a mainframe in a wired or wireless local area network and having an internal or external access space for storing the data copied from at least the mainframe, and the authority unit of at least the mainframe accessible by the hardware to actively and unilaterally grab and copy data from the mainframe and unilaterally write data in the process of backup data restore in the mainframe, and a consolidation unit designed for collation, compilation, compression and encryption of data in the access space, and a control unit to control the reading and writing of data in the mainframe and operation of the hardware;
particularly, the mainframe and other network devices are not authorized to log in the hardware, provide settings or perform data access, therefore, the hardware being under real protection against attacks by viruses, ransomware and hackers.

2. The active network backup device as claimed in claim 1, wherein the hardware can only conduct backup and restore operations in direct or indirect connection with at least a mainframe in a wired or wireless local area network due to absence of access to the Internet in order to fundamentally prevent intrusion of malicious programs

3. The active network backup device as claimed in claim 1, wherein the hardware, further has a setting unit and an independent wired or wireless port, the setting unit being a program setting unit designed for data backup and restore of the mainframe, and the independent wired or wireless input/output port being the essential device used for connecting the hardware to external devices (e.g. mobile devices, keyboard, mouse or monitor) for operation and setting of the setting unit, the connections between the external devices and the hardware being independent and isolated from the connection between the hardware and the mainframe, to forbid setting and operation of the hardware with the mainframe and thereby prevent intrusion of viruses, ransomware and hackers into the hardware through the mainframe.

4. The active network backup device as claimed in claim 1, wherein the hardware, further has a detection and warning unit, the detection and warning unit being mainly used for detection of the copied data in the access space or original data in the mainframe to be copied and further control over the warning notifications given by a warning component of the hardware; the warning component is a speaker, buzzer, flasher or acousto-optic device, or a program of warning functions installed in and connected to the mainframe and warning users via acousto-optic approaches, message or email from the mainframe upon notification given by the program.

5. The active network backup device as claimed in claim 1, wherein the hardware, further has a switch designed for forcibly breaking the working connection between the hardware and the mainframe and used for automatically or manually breaking the connection between the hardware and the mainframe when the system gives warnings of virus or hacker intrusion.

6. The active network backup device as claimed in claim 1, wherein the hardware can be installed in at least a mainframe or have independent settings.

7. An active network backup device having a physical security switch, comprised of:
at least a mainframe having an authority unit;
a piece of hardware directly or indirectly connected to at least a mainframe in a wired or wireless local area network and having an internal or external access space for storing the data copied from at least the mainframe, and the authority unit of at least the mainframe accessible by the hardware to actively and unilaterally grab and copy data from the mainframe and unilaterally write data in the process of backup data restore in the mainframe; the hardware has a physical security switch controlling at least one wired or wireless independent input/output port of the hardware with the independent input/output port being used for connecting external input devices to complete backup and restore program settings of the hardware, the physical security switch being at least comprised of a manual switch, a lock or a fingerprint or iris recognition device.
particularly, before the administrator creates or changes the settings of the mainframe with the hardware, the physical security switch must be opened manually in order to access the independent input/output port and complete settings of the hardware to ensure prevention against hacking of robot programs by the administrator's personal operation.

8. The active network backup device as claimed in claim 7, wherein the hardware has an identity recognition unit requiring the administrator to pass an identity verification program by entering password or voice recognition before login and operation of the hardware when the physical security switch is manually turned on and no fingerprint or iris recognition is applied, in order to ensure personal operation of the administrator.

9. The active network backup device as claimed in claim 7, wherein the physical security switch has the automatic shutdown structure resetting the timer and postponing the automatic disconnection function when receiving the correct setting message within the effective timing period to avoid negligence of administrator in personal operation from forgetting to shut down the independent input/output port of the hardware or disconnect the hardware from the keyboard, mouse, monitor, mobile phone, portable devices and other external input/output devices used in the process of hardware setting.

10. The active network backup device as claimed in claim 9, wherein the automatic shutdown structure will first give a warning of the coming disconnection when meeting the shutdown conditions to ensure that users can postpone the automatic shutdown by repeating the operation on the physical security switch or entering the correct setting message.

11. An active network backup device having the function of excluding destructive instructions, comprised of:
at least a mainframe having an authority unit;
a piece of hardware directly or indirectly connected to at least a mainframe in a wired or wireless local area network and having an internal or external access space for storing the data copied from at least the mainframe, and the authority unit of at least the mainframe accessible by the hardware to unilaterally grab and copy data from the mainframe and unilaterally write data in the process of backup data restore in the mainframe;
particularly, to ensure the security of backup files, the hardware cannot execute destructive instructions, such as deleting, revising or opening files (execution of files) or other instructions to destroy or change files but the nondestructive instructions such as creating, moving, copying, backup and restore of data, in case of any backup data copied to the hardware being previously infected by viruses, considering the failure in execution and running of viruses in the hardware, the backup data being protected from destruction, accidental deletion due to setting errors, or any ransomware or malicious programs in the disguise of setting programs being downloaded and executed by careless users.

12. The active network backup device as claimed in claim 11, wherein the hardware has a serial port for connection with external backup media with the serial port being used for connecting to storage media in order to save space by moving the old and outdated backup data from the access space, and in the process of execution of the moving instruction, no moving instruction due to absence of external medium connected to the hardware.
